(19) United States
(12) Patent Application Publication
(10) Pub. No.: US 2022/0366654 A1
(43) Pub. Date: Nov. 17, 2022

(54) SYSTEM AND METHOD FOR MAKING A CUSTOM MINIATURE FIGURINE USING A THREE-DIMENSIONAL (3D) SCANNED IMAGE AND A PRE-SCULPTED BODY

(71) Applicant: HOPLITE GAME STUDIOS INC, Kinnelon, NJ (US)

(72) Inventors: Michael J. Elices, Kinnelon, NJ (US); Raisa Da Silva, Kinnelon, NJ (US)

(73) Assignee: HOPLITE GAME STUDIOS INC, Kinnelon, NJ (US)

(21) Appl. No.: 17/742,680

(22) Filed: May 12, 2022

Related U.S. Application Data
(60) Provisional application No. 63/187,500, filed on May 12, 2021.

(51) Int. Cl. G06T 19/00; G06T 15/20; G06T 17/00; G06K 7/14; G06V 40/16; G06V 40/10

(52) U.S. Cl. CPC G06T 19/006; G06T 15/205; G06T 17/00; G06K 7/1417; G06V 40/169; G06V 40/103; G06T 2200/08; G06T 2200/24

(57) ABSTRACT

A system and method for making a custom miniature figurine using a 3D scanned image and a pre-sculpted body is described herein. The system includes a database, a server, a computing device, an automated distributed manufacturing system, and a 3D printing apparatus. An application of the computing device utilizes a camera of the computing device to scan a head of a user, create a 3D representation of the head of the user from the scans, combine the 3D representation of the head of the user with a pre-sculpted digital body and/or accessories selected by the user to create a work order, and transmit the work order to the automated distributed manufacturing system. The automated distributed manufacturing system performs digital modeling tasks, assembles a digital model, and transmits the digital model to the 3D printing apparatus. The 3D printing apparatus creates the custom miniature figurine.

### CROSS-REFERENCE TO RELATED APPLICATIONS SECTION

This application is a U.S. Non-Provisional patent application that claims priority to U.S. Provisional Patent Application Ser. No. 63/187,500 filed on May 12, 2021, the entire contents of which are hereby incorporated by reference in their entirety.

### FIELD OF THE EMBODIMENTS

This invention relates to a system and method for making a custom miniature figurine using a 3D scanned image and a pre-sculpted body.

### BACKGROUND OF THE EMBODIMENTS

Various manufacturing technologies, such as numerically controlled machining, stereolithography, or 3D printing can be used to create 3D models of a person or object. These systems require placing an order for a 3D model via the Internet. Further, these systems provide very little customization and only allow the user to select pre-made poses for the model and/or optional parts (e.g., hats, gloves, etc.) for the model. Thus, though traditional systems provide custom miniature 3D models, the processes required to make these 3D models are time consuming and expensive to manufacture. Moreover the choice of materials is usually limited, and the object typically must be made of a single material. Further, these known systems do not provide personalized aspects unique to an individual user. Thus, what is needed is a system and method for making a custom miniature figurine using a 3D scanned image and a pre-sculpted body. The present invention meets and exceeds these objectives.

### REVIEW OF RELATED TECHNOLOGY

U.S. Pat. No. 9,959,453B2 describes a system for rendering a merged virtual 3D augmented replica of a 3D product image and a 3D model image of a body part. A 3D modeling engine transforms an acquired 2D image of a body part into a 3D augmented replica thereof. A GUI enables the merging, displaying and manipulating of the 3D product image and the 3D augmented replica of a body part.

U.S. Pat. No. 9,734,628B2 and U.S. Pat. No. 9,196,089B2 describe methods for creating digital assets that can be used to personalize themed products. For example, these references describe a workflow and pipeline that may be used to generate a 3D model from digital images of a person's face and to manufacture a personalized, physical figurine customized with the 3D model. The 3D model of the person's face may be simplified to match a topology of a desired figurine.

US20160096318A1 describes a 3D printer system that allows a 3D object to be printed such that each portion or object element is constructed or designed to have a user-defined or user-selected material parameter, such as varying elastic deformation. The 3D printer system stores a library of microstructures or cells that are each defined and designed to provide the desired material parameter and that can be combined during 3D printing to provide a portion or element of a printed 3D object having the material parameter. For example, a toy or figurine is printed using differing microstructures in its arms than its body to allow the arms to have a first elasticity (or softness) that differs from that of the body that is printed with microstructures providing a second elasticity. The use of microstructures allows the 3D printer system to operate to alter the effective deformation behavior of 3D objects printed using single-material.

U.S. Pat. No. 9,280,854B2 and WO2014093873A2 describe a system and method of making an at least partially customized figure emulating a subject. The method includes: obtaining at least two 2D images of the face of the subject from different perspectives; processing the images of the face with a computer processor to create a 3D model of the subject's face; scaling the 3D model; and applying the 3D model to a predetermined template adapted to interfit with the head of a figure preform. The template is printed and installed on the head portion of the figure preform.

AU2015201911A1 describes an apparatus and method for producing a 3D figurine. Images of a subject are captured using different cameras. Camera parameters are estimated by processing the images. 3D coordinates representing a surface are estimated by: finding overlapping images that overlap a field of view of a given image; determining a Fundamental Matrix relating geometry of projections of the given image to the overlapping images using the camera parameters; and, for each pixel in the given image, determining whether a match can be found between a given pixel and candidate locations along a corresponding Epipolar line in an overlapping image. When a match is found, the method includes: estimating respective 3D coordinates of a point associated with positions of both the given pixel and a matched pixel; and adding the respective 3D coordinates to a set. The set is converted to a 3D printer file and sent to a 3D printer.

U.S. Pat. No. 8,830,226B2 describes systems, methods, and computer-readable media for integrating a 3D asset with a 3D model. Each asset can include a base surface and either a protrusion or a projection extending from the base. Once the asset is placed at a particular position with respect to the model, one or more vertices defining a periphery of the base surface can be projected onto an external surface of the model. Then, one or more portions of the asset can be deformed to provide a smooth transition between the external surface of the asset and the external surface of the model. In some cases, the asset can include a hole extending through the external surface of the model for defining a cavity. A secondary asset can be placed in the cavity such as, for example, an eyeball asset placed in an eye socket asset.

U.S. Pat. No. 8,243,334B2 describes systems and methods for printing a 3D object on a 3D printer. The method semi-automatically or automatically delineates an item in an image, receives a 3D model of the item, matches the item to the 3D model, and sends the matched 3D model to a 3D printer.

WO2006021404A1 describes a method for producing a figurine. A virtual 3D model is calculated from 2D images by means of a calculation unit. Data of the 3D model is transmitted to a control unit of a processing facility by means of a transmission unit. The processing facility includes a laser unit and a table with a reception facility for fixating a workpiece. Material is ablated from the workpiece by means of a laser emitted by the laser unit, where the workpiece is moved in relation to the laser unit and/or the laser unit is moved in relation to the workpiece, so that a scaled reproduction of the corresponding area of the original is created at least from parts of the workpiece.

Various systems are known in the art. However, their function and means of operation are substantially different from the present invention.

### SUMMARY OF THE EMBODIMENTS

The present invention comprises a system and method for making a custom miniature figurine using a 3D scanned image and a pre-sculpted body.

A first embodiment of the present invention describes a system configured to create a custom miniature figurine. The system includes numerous components, such as, but not limited to, a database, a server, a computing device, an automated distributed manufacturing system, and a 3D printing apparatus. The computing device includes numerous components, such as, but not limited to, a graphical user interface (GUI), a camera, and an application.

The application of the computing device is configured to: utilize the camera to scan a head of a user and create a 3D representation of the head of the user. It should be appreciated that the application comprises an augmented reality (AR) process (e.g., an augmented reality miniature maker (ARMM)) configured to: track movement values and pose values of the user and apply at least a portion of the movement values and the pose values to the digital model. Moreover, the application of the computing device is configured to: combine the 3D representation of the head of the user with a pre-sculpted digital body and/or accessories selected by the user via the GUI to create a work order. In some examples, the application comprises an automated miniature assembly (AMA) script configured to automate an assembly of the digital model. The application of the computing device is also configured to transmit the work order to the automated distributed manufacturing system.

The automated distributed manufacturing system is configured to receive the work order from the application, perform digital modeling tasks and assemble a digital model, and transmit the digital model to the 3D printing apparatus. The automated distributed manufacturing system is also configured to print tactile textures (e.g., playing surfaces) and integrated physical anchors on a packaging, which may occur by layering ultraviolet (UV) curable ink. The integrated physical anchors comprise integrated QR codes such that scanning QR codes by the camera creates audiovisual effects and/or digital models that appear via AR. Also, the packaging is configured to unfold and disassemble to reveal a board game. The 3D printing apparatus is configured to receive the digital model and create the custom miniature figurine.

A second embodiment of the present invention describes a method executed by an application of a computing device to create a custom miniature figurine. The method includes numerous process steps, such as: using a camera of a computing device to take measurements of a head of a user, compiling the measurements of the head of the user into a 3D representation of the head of the user, combining the 3D representation of the head of the user with a pre-sculpted digital body and/or accessories selected by the user via a GUI of the computing device to create a work order, and transmitting the work order to an automated distributed manufacturing system. The automated distributed manufacturing is configured to: perform digital modeling tasks, assemble a digital model, and transmit the digital model to a 3D printing apparatus. The 3D printing apparatus is configured to create the custom miniature figurine from the digital model.

At the basic level, all instances use AMA. Some instances additionally use ARMM, which generates additional pose data based on the user's body movements. The purpose of AMA is to assemble the model, normally the head and body. ARMM tracks the position of a user's body to further modify the model, but this is still utilizing the AMA.

The automated distributed manufacturing system is configured to: print tactile textures on a packaging by layering UV-curable ink and print integrated physical anchors on the packaging. The integrated physical anchors comprise integrated QR codes, such that scanning the QR codes via the camera creates audiovisual effects and/or digital models that appear via AR. Moreover, the packaging is configured to unfold and disassemble to reveal a board game.

The custom miniature figurine is a tabletop miniature figurine used for tabletop gaming and/or display that may range in size from approximately 1:56 to approximately 1:30 scale. In some examples, the custom miniature figurine comprises a base that has a size between approximately 25 mm to approximately 75 mm.

### BRIEF DESCRIPTION OF THE DRAWINGS

FIG. 1 depicts a schematic diagram of a server, an AMA script, and a database/local storage/network storage of a system to create a custom miniature figurine, according to at least some embodiments disclosed herein.

FIG. 2 depicts a schematic diagram of a server, an AMA script, a pose recreation process, a mobile application, and a database/local storage/network storage of a system to create a custom miniature figurine, according to at least some embodiments disclosed herein.

FIG. 3 depicts a schematic diagram of a union/attachment process, a difference debossing process, and a shrink wrap/smoothing processed used by a system to create a custom miniature figurine, according to at least some embodiments disclosed herein.

FIG. 4 depicts a schematic diagram of a server, 3D modeling software, a 3D printer, and a network of a system to create a custom miniature figurine, according to at least some embodiments disclosed herein.

FIG. 5 depicts a schematic diagram of a mobile application, a server, a 3D printer, and a network of a system to create a custom miniature figurine, according to at least some embodiments disclosed herein.

FIG. 6 depicts a schematic diagram of components assembled to create a custom miniature figurine, according to at least some embodiments disclosed herein.

FIG. 7 depicts a block diagram of a method executed by an AMA script, according to at least some embodiments disclosed herein.

FIG. 8 depicts a block diagram of a method executed by an ARMM, according to at least some embodiments disclosed herein.

FIG. 9 depicts images of integrated QR codes and tokens used by a system, according to at least some embodiments disclosed herein.

FIG. 10 depicts images associated with a method of creating textured playing surfaces upon a rigid substrate using UV-curable printing ink, according to at least some embodiments disclosed herein.

FIG. 11 depicts additional images associated with a method of creating textured playing surfaces upon a rigid substrate using UV-curable printing ink, according to at least some embodiments disclosed herein.

FIG. 12 depicts an image of a 3D scanned head of a user, according to at least some embodiments disclosed herein.

FIG. 13 depicts an image of a 3D representation of the head of the user, according to at least some embodiments disclosed herein.

FIG. 14 depicts a listing of pre-sculpted bodies selectable by the user via an application of a computing device to be used with a custom miniature figurine, according to at least some embodiments disclosed herein.

FIG. 15 depicts an image of a preview of a custom miniature figurine, according to at least some embodiments disclosed herein.

FIG. 16 depicts an AMA digital rendering in augmented reality alongside a custom miniature figurine, according to at least some embodiments disclosed herein.

FIG. 17 depicts images of a 32 mm and a 175 mm custom miniature figurine, according to at least some embodiments disclosed herein.

FIG. 18 depicts an image of a 32 mm custom miniature figurine, according to at least some embodiments disclosed herein.

FIG. 19 depicts images of a 32 mm custom miniature figurine, according to at least some embodiments disclosed herein.

FIG. 20 depicts images of 32 mm custom miniature figurines, with an image on the left being painted by a user, according to at least some embodiments disclosed herein.

FIG. 21 depicts an image of packaging, according to at least some embodiments disclosed herein.

FIG. 22 is a block diagram of a computing device included within the computer system, in accordance with embodiments of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

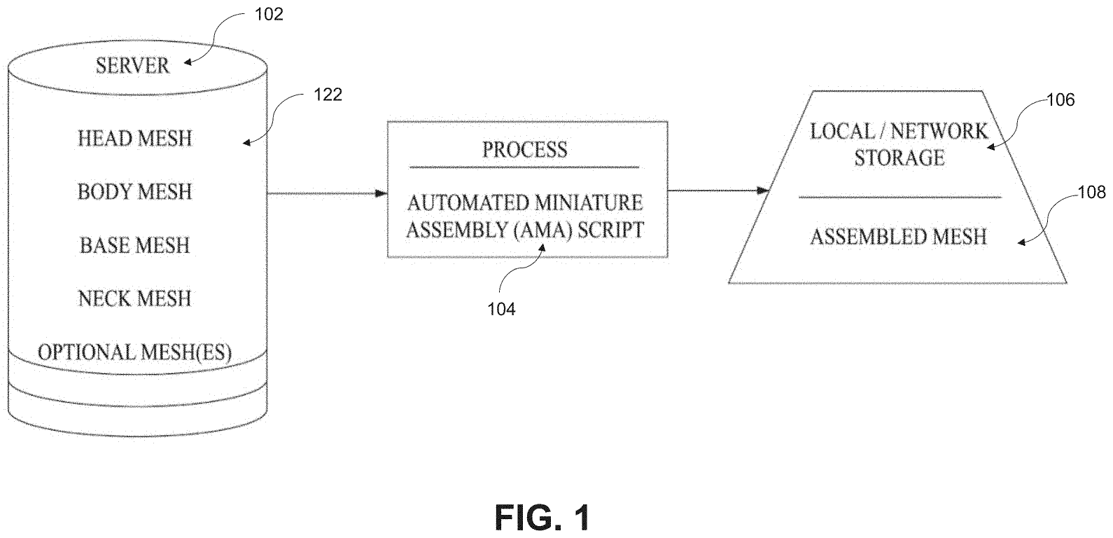

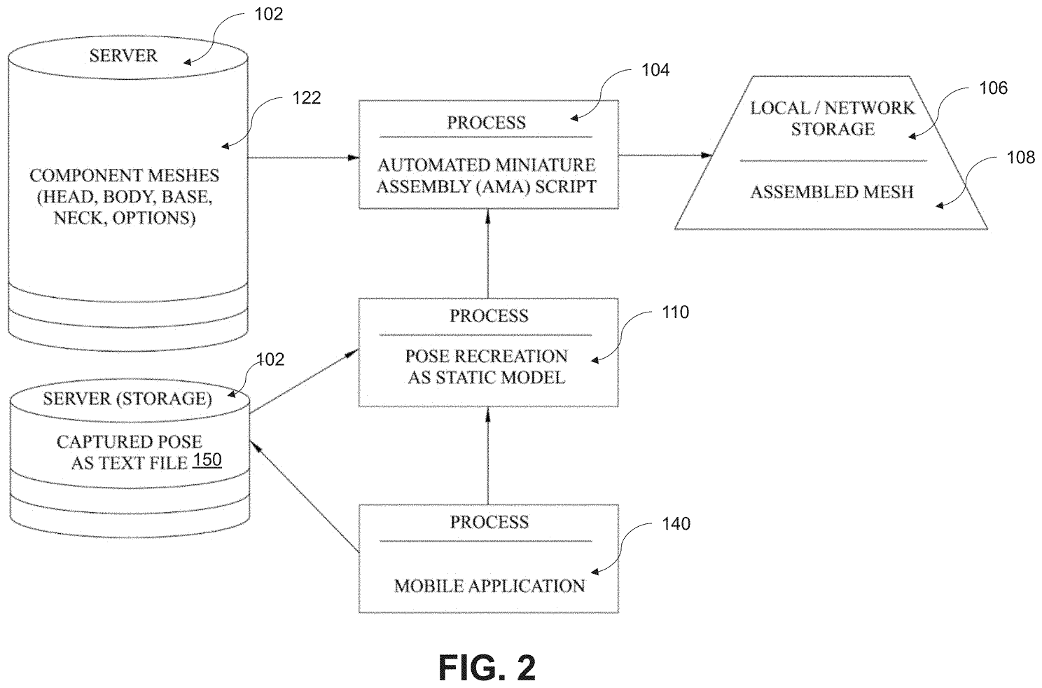

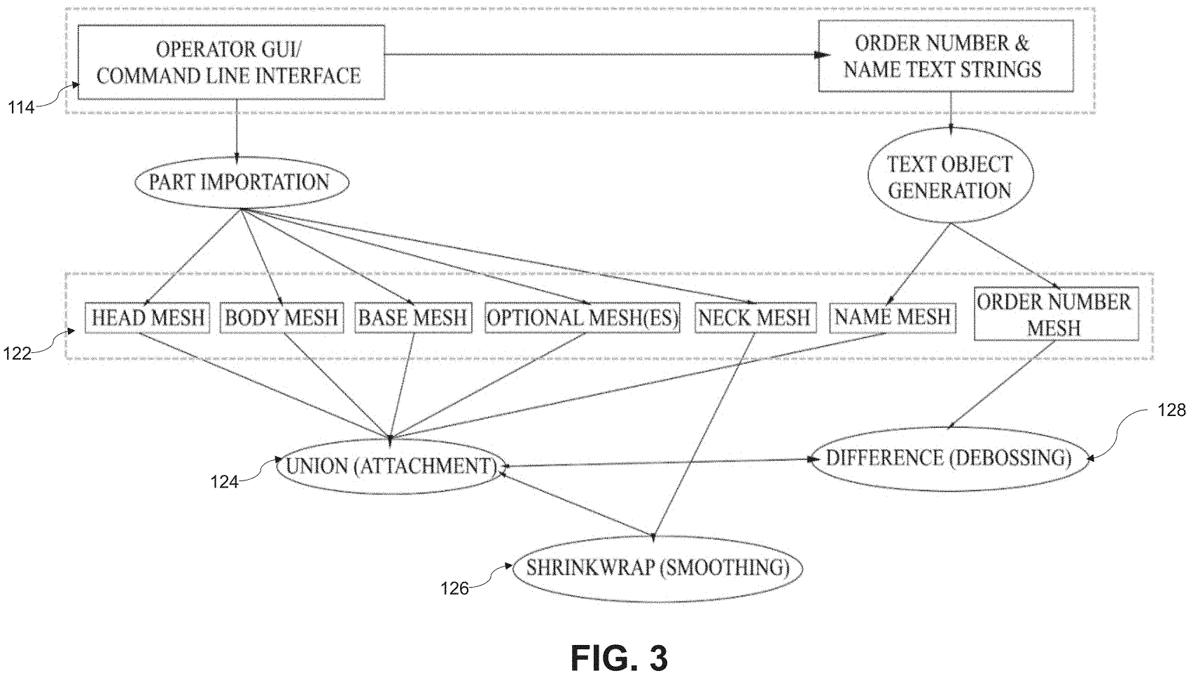

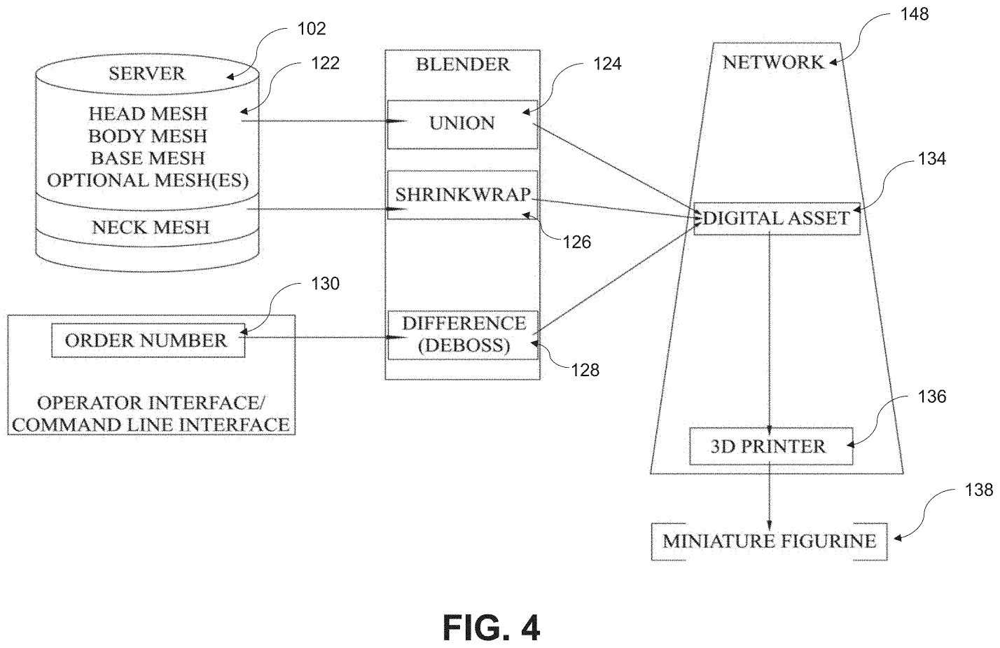

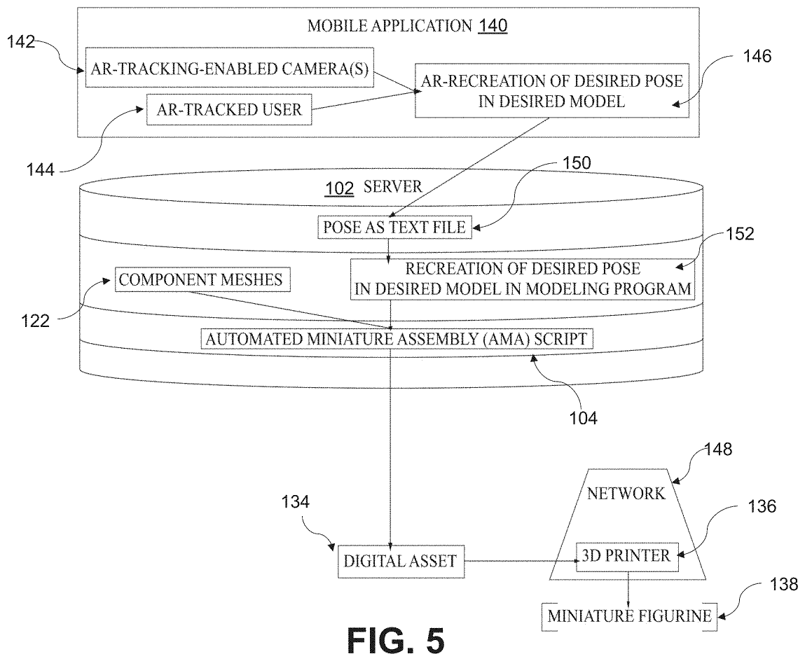

A system and method for making a custom miniature figurine 138 using a 3D scanned image and a pre-sculpted body are described herein. More specifically, FIG. 1 depicts a schematic diagram of a server 102, an automated miniature assembly (AMA) script 104, and a database/local storage/network storage 106 of the system. FIG. 2 depicts a schematic diagram of the server 102, the AMA script 104, a pose recreation process 110, a mobile application 140, and the database/local storage/network storage 106 of the system. FIG. 3 depicts a schematic diagram of a union/attachment process 124, a difference debossing process 128, and a shrink wrap/smoothing process 126 used by the system. FIG. 4 depicts a schematic diagram of the server 102, 3D modeling software, a 3D printer apparatus 136, and a network 148 of the system. FIG. 5 depicts a schematic diagram of a mobile application 140, the server 102, the 3D printer apparatus 136, and a network 148 of the system.

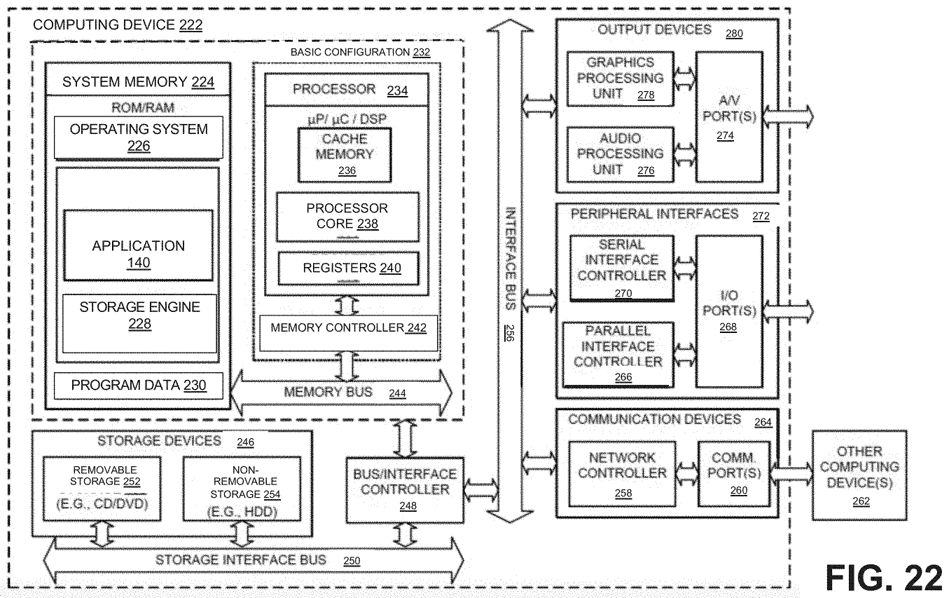

As described, the system may include numerous components, such as, but not limited to, the database/local storage/network storage 106, the server 102, a network 148, a computing device 222 (of FIG. 22), an automated distributed manufacturing system, and the 3D printer apparatus 136. As shown in FIG. 1, the server 102 may be configured to store information, such as meshes 122 (e.g., head mesh, body mesh, base mesh, neck mesh, etc.), among other information. Moreover, the database/local storage/network storage 106 may be configured to store information, such as assembled meshes 108, among other information.

The computing device 222 may be a computer, a laptop computer, a smartphone, and/or a tablet, among other examples not explicitly listed herein. In some implementations, the computing device 222 may comprise a standalone tablet-based kiosk or scanning booth such that a user 144 may engage with the computing device 222 in a handsfree manner. The computing device 222 includes numerous components, such as, but not limited to, a graphical user interface (GUI) 114, a camera 142 (e.g., a Light Detection and Ranging (LiDAR) equipped camera), and the application 140. In examples, the application 140 may be an engine, a software program, a service, or a software platform configured to be executable on the computing device 222.

The primary use of the application 140 is the integration of 3D scanning technology utilizing depth-sensor enabled computing device cameras 142, such as Apple's Trudepth Camera, to rapidly create 3D models of a user's head without the need for specialized scanning equipment or training. This process is described in U.S. Pat. No. 10,157,477, the entire contents of which are hereby incorporated by reference in their entirety.

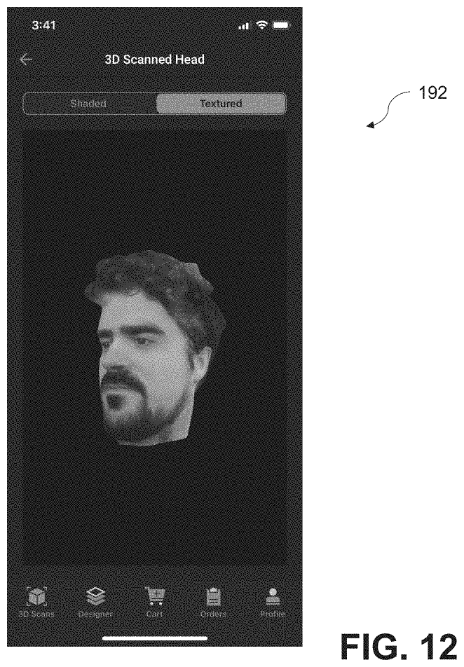

More specifically, the application 140 of the computing device 222 is configured to perform numerous process steps, such as: utilizing the camera 142 of the computing device 222 to scan a head of the user 144. An illustrative example of the scanned image 192 is depicted in FIG. 12. In some examples, the user 144 is guided by audio, textual, and/or graphical instructions via the application 140 as to how they should move their computing device 222, head, and/or body for a successful scan. It should be appreciated that the very back of a user's head is excluded from the scan and is instead filled using an algorithmic approximation. As the scan is performed within the confines of a 2D set of boundaries, long hair and beards are frequently cut off in the scan. To adjust for this, the user 144 can select a pre-made model of hair/beard to approximate their real hair/beard when they choose a model. The user 144 can take and save multiple scans with different expressions for later use. The scans are stored in the users personal library (“scan library”) in the database/local storage/network storage 106.

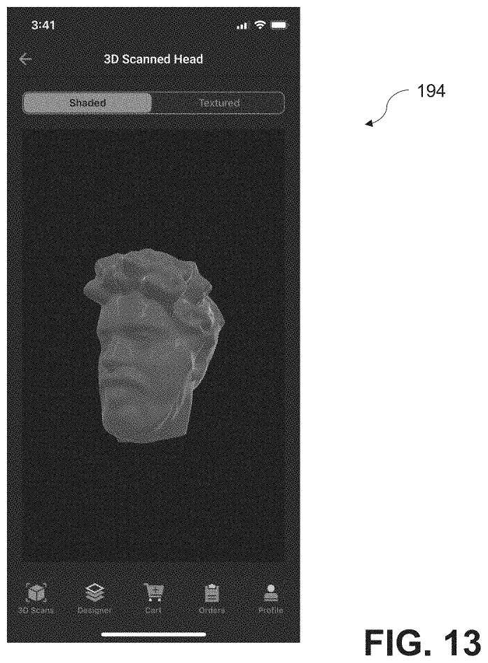

The application 140 of the computing device 222 is also configured to: create a 3D representation 194 of the head of the user 144 from the scans, as shown in FIG. 13. The 3D representation of the head of the user 144 may also be saved in the database/local storage/network storage 106.

It should be appreciated that, as described herein, the scanning methods transform the user's 144 own existing consumer electronics (e.g., the computing device 222) into a 3D scanning experience without the need for specialized training or professional hardware. This method is focused on self-scanning, digital manipulation by a non-professional user, and software automation of nearly all complex labor previously involved.

Other scanning methods are also contemplated by the instant invention. A first alternative scanning method requires the camera 142 of the computing device 222 to be a depth-enabled camera. In some examples, this depth-enabled camera may be the TrueDepth camera. However, it should be appreciated that the depth-enabled camera is not limited to such. The scanning process is activated through use of the application 140. With this first method, the user 144 takes multiple depth images of themselves from several different angles as instructed by the application 140 of the present invention. The process is designed to be executed independently without the need for outside human assistance, specialized training, or professional equipment. If the user 144 is performing this as a “selfie” and holding the computing device 222 at an arms distance from a face of the user 144, the user 144 would rotate their head based upon audio or visual commands from the application 140 of the computing device 222, which guides the user 144 to move in multiple directions to capture data from as much of the human head as physically possible. It should be appreciated that it is not physically possible for the user 144 to rotate the full 360 degrees to capture data from the entirety of the head of the user 144. As such some gaps are left, which the application 140 fills in.

In this first method, each of the images generates a point cloud, with each point being based upon a measured time of flight between the camera 142 and a point on the head of the user 144. These images are then converted into “point clouds” using depth data as the Z-Axis. As described herein, a “point cloud” is a set of data points in 3D space, where each point position has a set of Cartesian coordinates (X, Y, Z). The points together represent a 3D shape or object.

The application 140 is then configured to clean up the point clouds and join the point clouds together to create a 3D map of the head of the user 144. To do so, machine-learning derived algorithms of the application 140 detect specific features of the head of the user 144 and align the individual point cloud images into a single point cloud. These same machine-learning derived algorithms of the application 140 are also used to detect various facial features of the face of the user 144 and modify them to improve models for the 3D printing process. For tabletop miniatures, features such as the eyes, the mouth, and the hairline of the user 144 are modified and digitally enhanced or manipulated by the machine-learning derived algorithms of the application 140 for the purpose of making the custom miniature figurine 138 more visually appealing and recognizable at small scales, most often the tabletop industry standard of 1:56. The machine-learning derived algorithms of the application 140 may also detect and modify facial features for manufacturing purposes, modifying the 3D model to avoid manufacturing errors or defects based upon machine specifications. The digitally assembled 3D models have two distinct uses: (1) they can be 3D printed as a miniature figurine (e.g., the custom miniature figurine 138) designed for use in Tabletop Gaming; and (2) they could be used with packaging 200 (or an “Adventure Box”) as a digital avatar presented in AR.

Next, the application 140 attempts to transform this point cloud into a fully watertight and solid mesh. In the likely scenario that data is missing due to an inability of the user 144 to rotate their head fully, the machine-learning derived algorithms of the application 140 detect these defects and attempt to fill in the missing areas based upon the current data or upon a library of relevant data. In other words, the gap is “closed” based on what the rest of the head of the user 144 looks like, or by using the library of existing data to estimate what a human head is typically shaped like. If the process is successful, the 3D mesh is now saved to a cloud-based database from which it can be stored and retrieved at a later point for the assembly process. For the user 144, a 3D model with or without color data is now presented.

It should be appreciated that though this method was described without the use of color or texture data, such color and/or texture data may be used, as full color 3D printing options are available. In this case, color images are captured during the scanning process described herein, and these images are combined and attached to the 3D mesh as the final step, with the machine learning algorithms of the application 140 again being employed to both “stitch” the images by detecting overlapping features to correctly place them upon the 3D mesh.

A second alternative scanning method utilizes photogrammetry, where regular color photos (not depth data) are converted to the point clouds and then to meshes similarly to the first alternative scanning method. This typically requires many more images and the results are less certain, in that the margin of error, especially with regards to alignment, is much higher. This method also typically requires much more advanced machine learning, but has the significant advantage of not requiring anything beyond a standard digital camera.

Based upon software audiovisual instructions provided by the application 140, a series of images are taken of the user 144, with the individual incrementally rotating 360 degrees in a circle so that the camera 142 of the computing device 222 captures the user 144 from every side. Additional images may optionally be taken from other angles to capture the top of the head or other obscured angles of the user 144, but this is not always necessary. Specifically, this method allows the user 144 to additionally utilize standard digital cameras, such as a non depth-sensing digital camera available on a standard cell phone or the web camera of a laptop. In this instance, the images uploaded to the application 140 could be accessed via a handheld device and the application 140.

In a third alternative method, structured light scanners, such as Artec Eva or other professional-grade scanners, can be used to produce completed 3D models to be passed to the assembly process. This typically produces higher quality models, but requires expensive dedicated hardware and licensed software.

It should be appreciated that with any of the scanning methods described herein, after the scanning process is complete, the application 140 allows the user 144 the ability to inspect or modify their scans themselves. For example, the user 144 may interact with the GUI 114 of the computing device 222 to: rotate, scale, and translate parts of the scan; trim/remove parts of the scan; add pre-sculpted elements to the scan (such as hair or accessories); and/or to identify specific locations for further manipulation (such as determining coordinates for the placement of additional parts). As such, the application 140 provides the user 144 with control over the modification and “sculpting” process. Traditionally, this is a task performed by a trained professional operator using specific software.

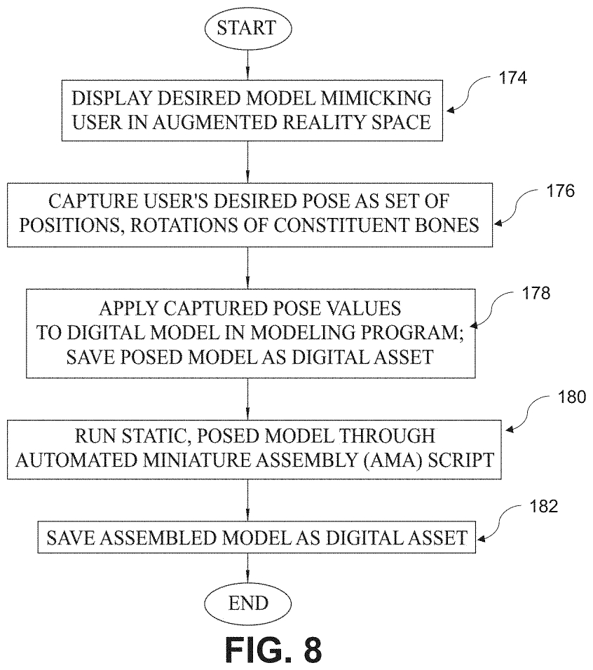

The application 140 comprises an augmented reality (AR) process (e.g., an augmented reality miniature maker (ARMM)) that is configured to: track movement values and pose values of the user 144 and apply at least a portion of the movement values and the pose values to the digital model (e.g., a part of the pose 146, the entirety of the pose 146, or the use of the pose 146 to manipulate parts of the custom miniature figurine 138). More specifically, a process executed by the ARMM script is depicted in FIG. 8. The ARMM uses Unity's ARFoundation to track the user 144 in real space. To be more precise, it tracks between 15 and 90 (depending on the model) features (“bones”) of the user 144 to approximate the position and pose 146 of the user's body. The ARMM then overlays the selected model on the user 144 and uses the tracked bones to deform the model to match the user's pose 146.

It should be appreciated that the ARMM process described herein may be used to customize a pre-sculpted 3D model according to the physical movements of the user 144 for the purposes of: (1) producing unique miniature figurines, (2) producing unique 3D model(s) for use in AR/virtual reality (AR/VR) digital space, or (3) producing unique animations for 3D model(s) for use in AR/VR digital space.

In a first method, the user 144 selects a pre-sculpted model to customize and the application 140 provides the selected model in the AR space. Next, the application 140 prompts the user 144 to step into a tracked physical space. The pre-sculpted model is automatically deformed to mirror physical movements of the user 144 via Unity's ARFoundation. When the user 144 engages a button on the GUI 114 of the computing device 222, a timer expires or a voice command is issued, and a current pose of the pre-sculpt is saved to a text file. The model's pose is determined by its “armature”, or skeleton. ARFoundation's body tracking tracks several dozen “joints” on the user 144, which correspond to “bones” on the pre-sculpted model, and which are rotated/translated according to the tracked movements. When the pose is saved, the position and rotation of each bone is saved to a text file. In the cloud, the saved text file is used to deform the chosen pre-sculpt as a static model. The deformed model is saved and passed to the assembly process for the production of the final custom miniature figurine 138.

In an alternative method, Unity's ARFoundation may be replaced with custom designed software. In a ground-up custom-built solution, the deformed model could be exported directly, rather than saving the pose and then deforming the model again in a different environment.

Thus, ARMM may be used to: (1) duplicate a static pose from the user 144 onto a dynamic, pre-sculpted 3D model, (2) customize non-humanoid models through a pre-designed relationship (e.g., arms of the user 144 could be made to alter the movements of a horse's legs, or the swaying of a tree's branches), (3) after the posed model is processed, it could be used in digital space, rather than used for manufacturing a miniature, (4) rather than saving a single, static pose, this process could also be used to save a short animated sequence for use in AR/VR virtual space, and/or (5) track the movement of non-humanoids, such as pets (though the process must be customized for each case/species).

Further, in some implementations, the ARMM process can be modified to track only portions of the body of the user 144. For instance, only an upper half of the user 144 may be tracked to map their pose onto a seated figure. In another example, the user 144 may be missing a limb. In this case, the ARMM process may exclude the missing limb. If the user 144 excludes a portion of the model, the application 140 provides the user 144 with an option to have that limb/portion excluded entirely (e.g., the model will be printed without it), or the user 144 can select a pre-sculpted pose for that limb/portion.

Additionally, rather than capturing a single pose, a short animated sequence could be created. This would be a motion-capture sequence using an identical method to the capture of a single pose. This short sequence could be activated via AR/R triggers or the application 140, allowing the user 144 to create and share a short animation of their digital character inside of the confines of the physical gaming environment. In other examples, the ARMM process may be used to track poses onto humanoids and non-humanoids for advanced models, saving static poses and animated sequences for use in AR in packaging 200 (or an “Adventure Box”).

The method of FIG. 8 includes numerous process steps, such as: a process step 174, a process step 176, a process step 178, a process step 180, and a process step 182. The process step 174 includes displaying the desired model mimicking the user 144 in AR space. The process step 176 follows the process step 174 and includes capturing the users desired pose 146 as a set of positions and rotations of constituent bones.

The user 144 can capture their pose 146 by either pressing a button on the GUI 114 of the computing device 222, or alternatively, via a voice command. The positions and rotations of the tracked bones are then saved in a list in a text file 150. The user 144 is also given the ability to manually modify the pose 146 through the GUI 114 and directly alter values before marking the pose 146 as finished. These values can then be used to reproduce the captured pose 146 in the selected model, or in other models with compatible skeletons.

The process step 178 follows the process step 176 and includes applying captured pose values to a digital model in a modeling program 152 (of FIG. 5) and saving the posed model as a digital asset 134. In examples, the text file 150 may be used in 3D modeling software through a Python script to manipulate the model to reproduce the pose 146 to produce a static version of the model in that pose 146 (e.g., the pose recreation as the static model 110 of FIG. 2). The script manipulates the contents of the text file 150 to account for the transition from Unity's left-handed coordinate system to the 3D modeling software's right-handed coordinate system, if necessary.

The process step 180 follows the process step 178 and includes running the static, posed model through the AMA script 104, which will be described herein. The process step 182 includes saving the assembled model as the digital asset 134. The process step 182 concludes the method of FIG. 8.

This system of FIG. 8 can also be used in several other, novel ways. For instance, the selected model can be rigged in such a way that only the values of specific body parts of the user 144 are tracked, which would enable capturing of only the upper torso and arms for seated users 144 and models, or for users 144 without full usage of their legs. Partial pose captures can also be used in conjunction with pre-set poses. For instance, the user 144 with an amputated limb who wishes to design a model with two arms could capture their pose 146 minus the missing limb, and then either use a pre-set for the missing limb to complete the pose 146, or omit the pre-set limb. Using these two methods, physically disabled users could utilize the ARMM system to design personalized and uniquely posed miniatures, regardless of anatomical or physical limitations.

Non-humanoid models can also be rigged to change according to the user's pose 146. For example, a horse model could be rigged such that the user 144 can manipulate it while remaining standing. The user's limbs could map to the horse's including an adjustment for the different plane of movement, such that the user 144 raising an arm vertically moves one of the horse's legs horizontally. Models that are not anatomically similar to a human body can be controlled as well. For example, a user's pose 146 can be applied to a rigged model of a multi-limbed tree, whereby the user's arms control the simultaneous movement of multiple branches of a tree and the positioning of their torso and legs control the model's trunk.

Multiple captured poses, including those of different people, can also be used in conjunction for models that require the pose values of more than one person. For instance, a group model requiring 3 pose values could prompt the user(s) to capture 3 separate poses in succession, one after another for each individual in the model.

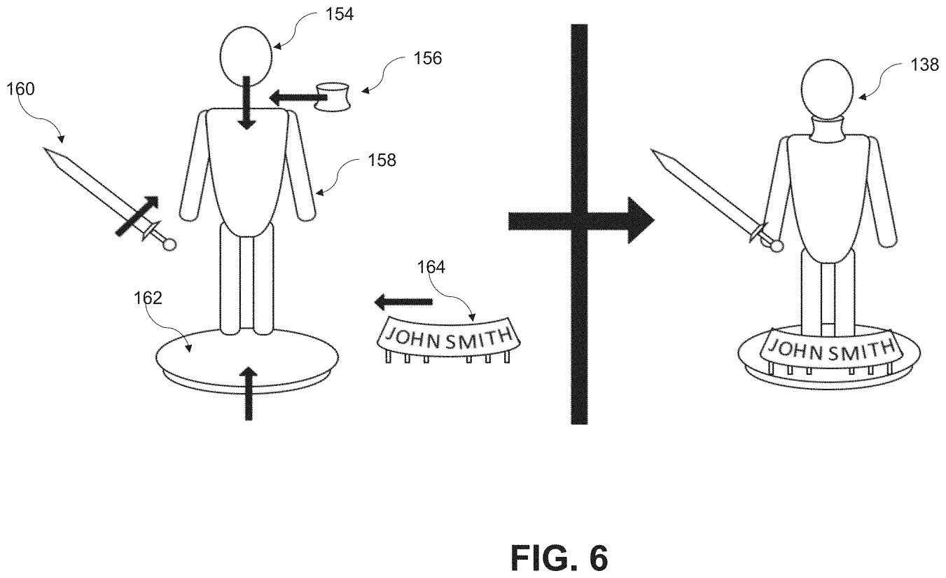

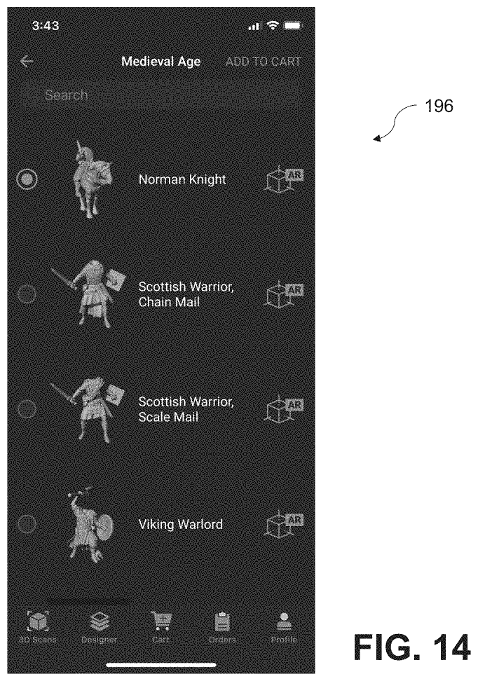

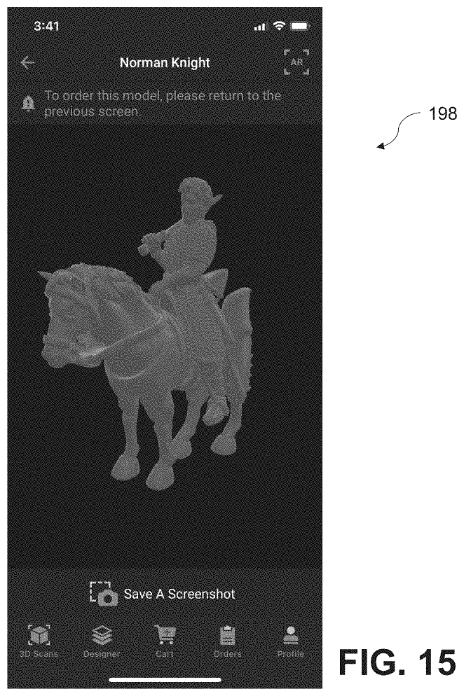

Additionally, the application 140 of the computing device 222 is configured to: combine the 3D representation of the head 154 of the user 144 with a pre-sculpted digital body 158 (including the movement/pose 146 detected), hair models, accessories 160, and/or a base 162 selected by the user 144 via the GUI 114 to create a work order, as shown in FIG. 6. Selection 196 of the pre-sculpted digital body 158 is depicted in FIG. 14. As such, the work order includes the 3D assets, such as the head 154, the body 158, the base 162, the neck 156, etc. FIG. 15 depicts an image 198 of a preview of the custom miniature figurine 138. In alternative embodiments, the application 140 can produce the text file 150 listing the component digital assets 134 to be pulled from the database/local storage/network storage 106 for assembly.

It should be appreciated that the pre-sculpted digital bodies are designed specifically to include pre-designed “scaffold” support structures required to the stereolithographic (SLA) 3D printing. This consists of a “raft”, which is a standardized horizontally oriented plate between 30 μm and 200 μm in thickness with angled edges designed to adhere to a 3D Printer's build platform, upon which a support structure of “scaffolds” arises to support the customized miniature figurine during the printing process.

The 3D assets described herein may be stored in the database/local storage/network storage 106. In some examples, the application 140 comprises the AMA script 104 configured to automate an assembly of the digital model (e.g., from the 3D assets). The AMA script 104 produces a single, completed and customized miniature figurine 138 ready for manufacturing via 3D printing (e.g., the 3D printer apparatus 136). Specifically, the AMA script 104 is used in every instance to combine a user's 3D scanned head with a pre-sculpted body. The user 144 may also place an order for the custom miniature figurine 138 via the application 140 of the computing device 222, where such work order is transmitted to the automated distributed manufacturing system. The user 144 may also be able to track the delivery status of their order via the application 140.

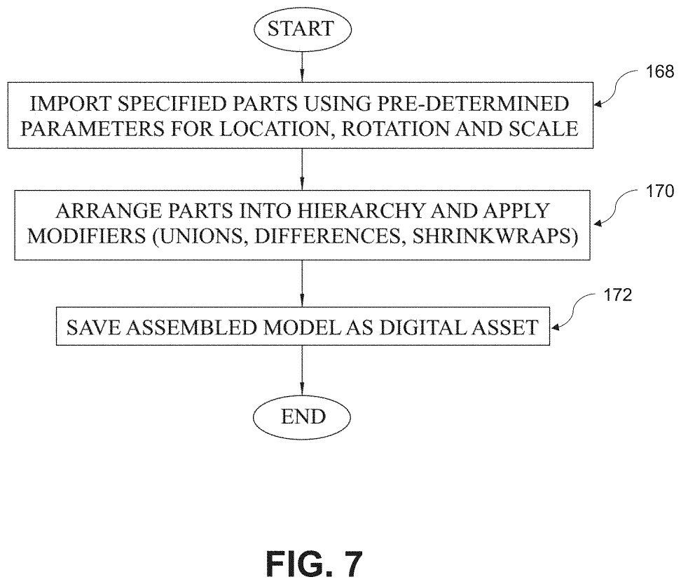

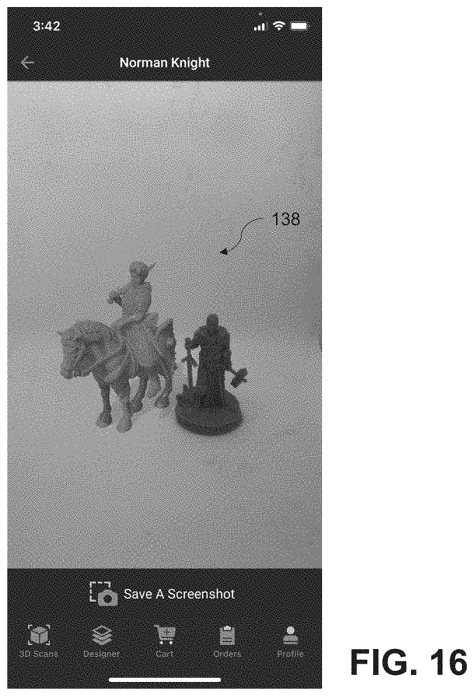

The process steps for the AMA script 104 are depicted in FIG. 7. According to FIG. 7, a method executed by the AMA script 104 includes a process step 168, a process step 170, and a process step 172. The process step 168 includes importing specified parts using pre-determined parameters for location, rotation, and scale. The process step 168 is followed by the process step 170 that includes arranging the parts into a hierarchy and applying modifiers (e.g., unions/attachments 124, differences/debossing 128, and shrink wraps/smoothing 128). The process step 172 follows the process step 170 and includes saving the assembled model as the digital asset 134. The process step 172 concludes the method of FIG. 7. FIG. 16 depicts an AMA digital rendering in AR alongside the custom miniature figurine 138.

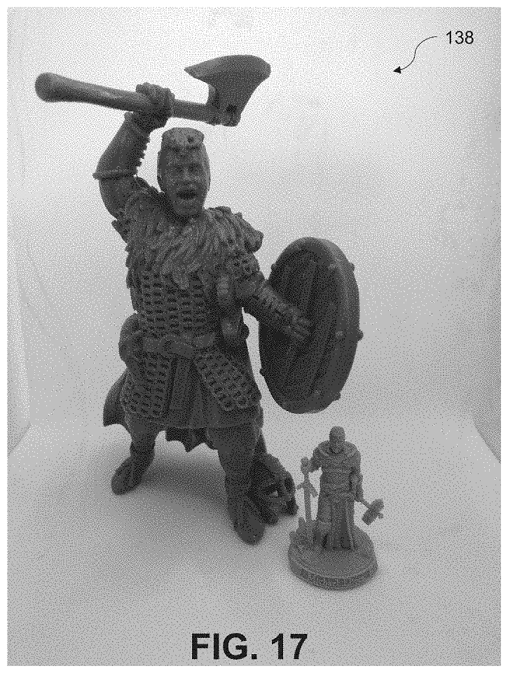

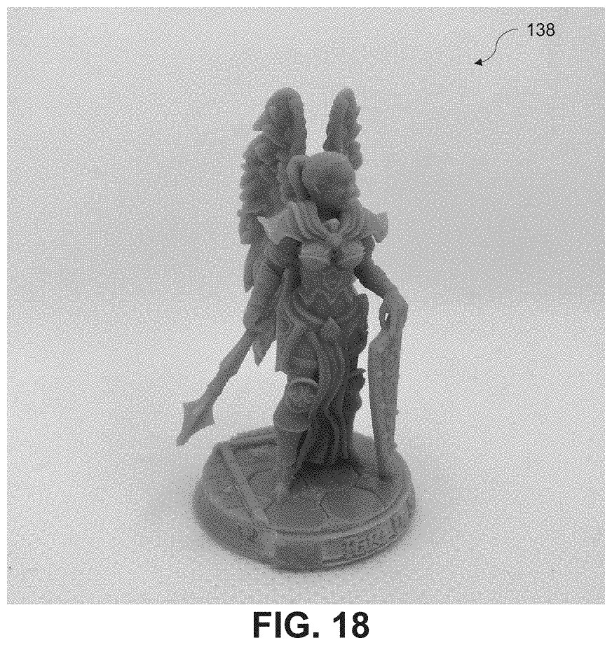

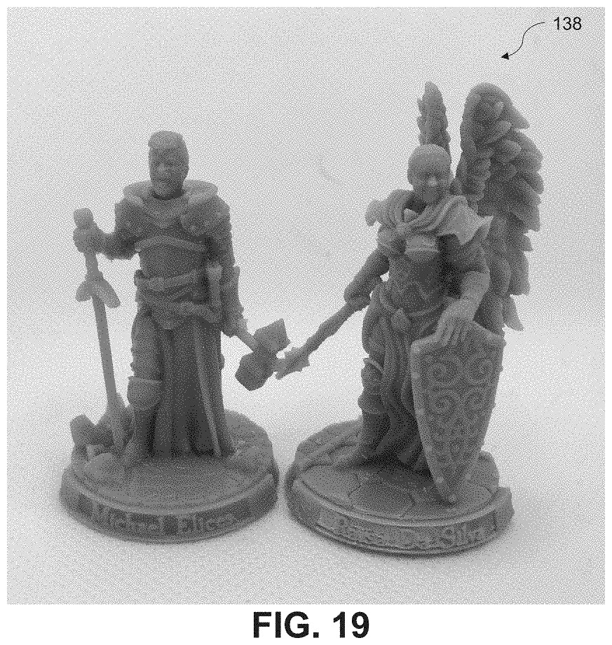

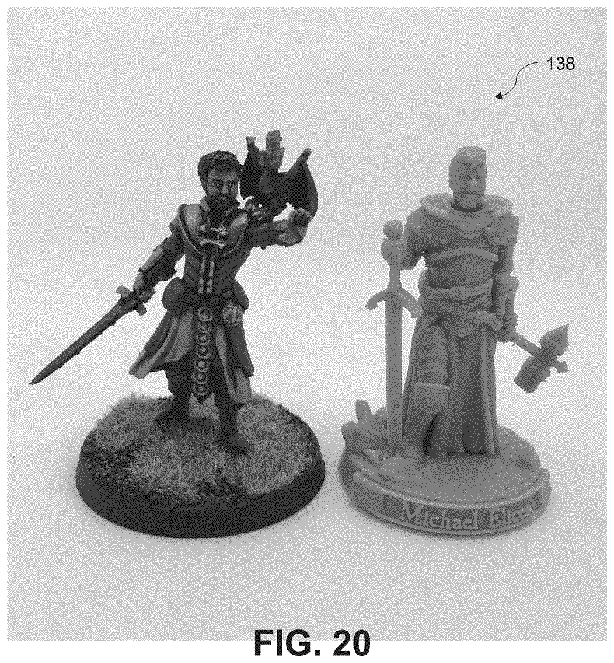

Next, the automated distributed manufacturing system utilizes a software process to replace a human sculptor. More specifically, the automated distributed manufacturing system is configured to receive the work order from the application 140, perform digital modeling tasks on the assembled model to prepare it for printing, and transmit the digital model to the 3D printer apparatus 136. The 3D printer apparatus 136 prints the custom miniature figurine 138. It should be appreciated that FIG. 17 depicts images of a 32 mm and a 175 mm custom miniature figurine 138. FIG. 18 depicts an image of a 32 mm custom miniature figurine 138. FIG. 19 depicts images of a 32 mm custom miniature figurine 138. FIG. 20 depicts images of 32 mm custom miniature figurines 138, with an image on the left being painted by a user.

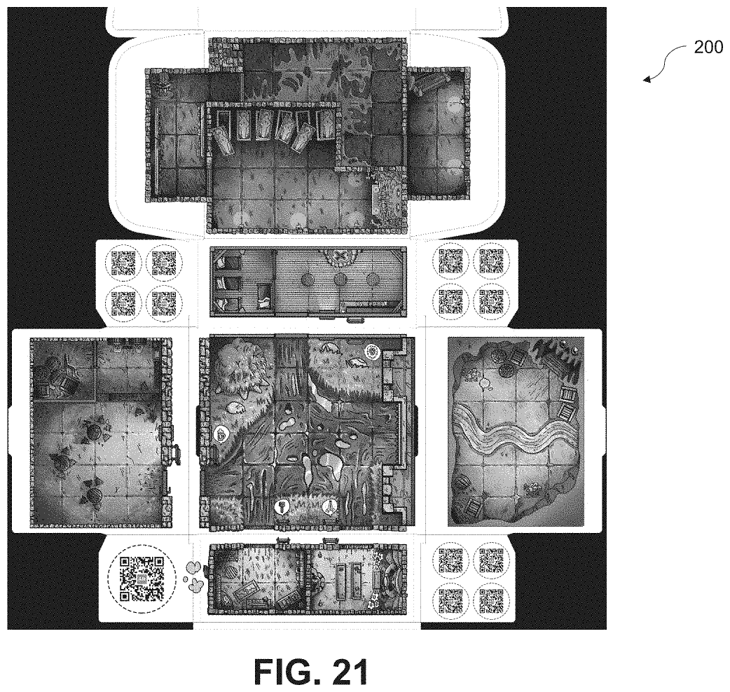

The automated distributed manufacturing system is also configured to print tactile textures (e.g., playing surfaces) and integrated physical anchors on the packaging 200 (or the “Adventure Box”), as shown in FIG. 21. Such method of printing tactile textures will be described herein. The packaging 200 is configured to unfold and disassemble to reveal a board game.

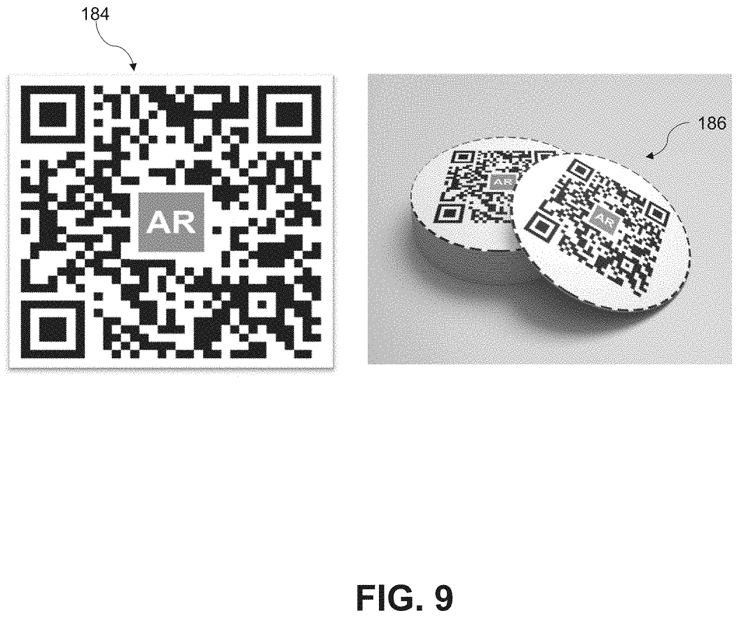

The integrated physical anchors comprise integrated QR codes 184 of FIG. 9 such that scanning QR codes 184 by the camera 142 of the computing device 222 creates audiovisual effects and/or digital models that appear via AR. In some examples, when scanned, the QR codes 184 produce an AR model on the gameboard, take the user 144 to an in-store link, or play a song, sound effect, or AR visual effect.

More specifically, the integrated physical anchors are used to distribute digital information and rule sheets to the participants (“file anchors”). This includes materials for a Game Master to use, character sheets for the players, and shared information and rules. Participants can play using only the digital copies, or they can print out physical versions to use.

Digital anchors are also used to augment the gameboard itself (“effect anchors”). When viewed through the use of the application 140, such effect anchors can present the user 144 with 3D elements and effects. For example, one anchor can add several trees around the gameboard, while another adds an animated fog effect above a section. Effect anchors can also be used to add flames, rain, lighting, or any other myriad of effects (including sound effects and music) to parts of the gameboard, or the whole game area.

Digital anchors can also be used in place of physical miniatures (“character anchors”). Character anchors can be printed onto the board itself, or onto separable cut-outs to provide both static and dynamic characters. For instance, static character anchors can add non-playable characters at specific locations around the gameboard, while dynamic anchors printed on separable tokens 186 of FIG. 9 can be used for movable playable characters. When the character or effects models used are available for purchase, the anchors can include links to their in-store listings, should the user(s) wish to purchase real, physical versions of the digital models.

When taken together and viewed through the application 140, digital anchors can augment and transform a static, printed packaging 200 or the Adventure Box into a full, 3D, animated game or scene featuring digital instructions, effects, sounds, and characters.

In some examples, the automated distributed manufacturing system may use custom die-cutting to create “punch out” tokens 186, which may serve as playing pieces. More specifically, tabs of the packaging 200 are prepared as partially scored approximately 25 mm to approximately 50 mm circular tokens 186 that a client/user 144 could “punch out” using their finger only after delivery and full disassembly of the package.

More specifically, a method of transforming full color digital illustrations into embossed 3D images that have distinct tactile feelings is described. This process occurs by manipulating the way in which UV-curable varnish ink is applied either through piezoelectric inkjet printers or through traditional offset press printing.

In commercial printing, raster image processor (RIP) software is used to perform color separations and designate ink droplet placement for the purpose of creating a full color image that consists only of cyan, magenta, yellow, and black ink. The human eye then interprets these colored dots as full vibrant colors. As a consequence of this CMYK color separation process, RIP software typically interprets non-color areas, such as varnish ink, as an alternative “spot color” of black ink and requires a negative image to interpret where this varnish should be placed. Varnish ink is also typically far thicker than standard ink, with an average layer height of approximately 15 microns to approximately 50 microns, whereas normal CMYK ink is only approximately 1 micron to approximately 3 microns. Normally, varnish would be applied on top of a CMYK image to protect it or provide a “gloss” look to the image. In the method described herein, this process is purposefully reversed, allowing us to build up textures below the CMYK image in a similar method to 3D printing, resulting in a tactile hidden texture.

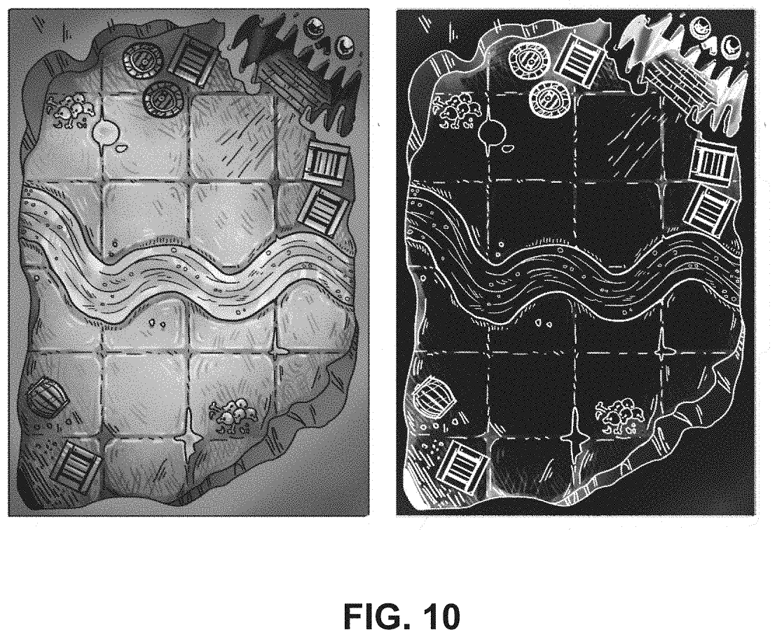

In a first example depicted in FIG. 10, to do so, a separate printing file must be first prepared in a software program, such as Adobe Photoshop. This file ideally contains only three colors: white, gray, and black. In doing so, RIP software that interprets varnish ink as black ink will produce no ink in the white areas, 50% coverage in the gray areas, and 100% coverage in the black areas, resulting in a variable 3D height map of corresponding to, for example, 0, 15, and 30 microns respectively.

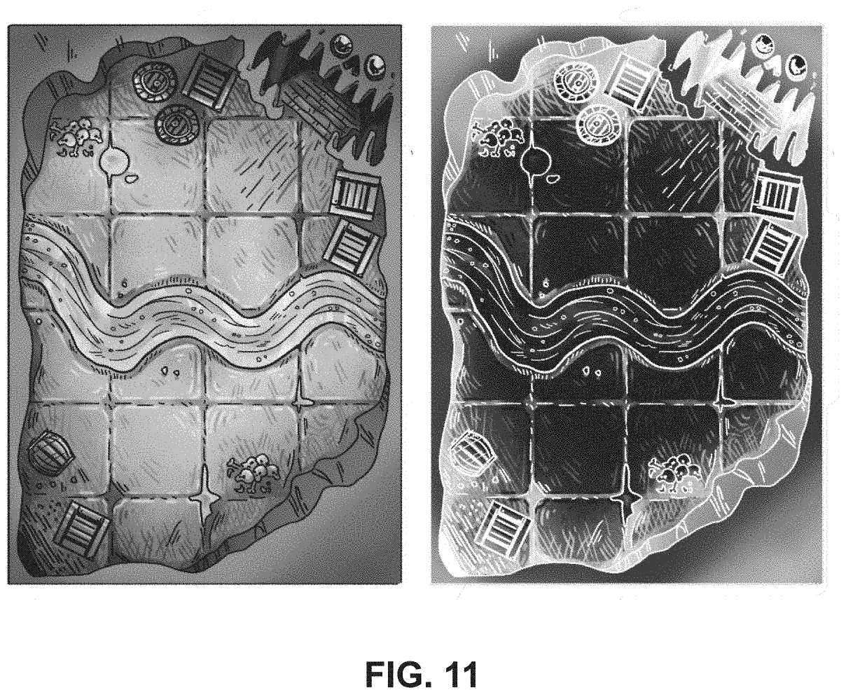

Alternatively, in a second example depicted in FIG. 11, a wider black-white gradient can be created using a simplified design process, but the results typically require multiple passes of UV Curable ink to create notable texture. This can be done by first transforming a full color artwork into a black and white image, and then increasing the contrast and brightness significantly until there is a clear difference between the dark and light areas.

In either process described herein of FIG. 10 and FIG. 11, multiple layers of UV curable varnish ink are applied in succession atop each other in a similar method to SLA 3D printing, building up a visible textured surface. Once a suitably high layer height has been established, CMYK ink can be placed upon this textured surface, resulting in a full-color image that both looks and feels like a particular material.

The 3D printer apparatus 136 described herein is configured to receive the digital model and create the custom miniature figurine 138. The custom miniature figurine 138 is a tabletop miniature figurine used for tabletop gaming and/or for display and may range in size from approximately 1:56 to approximately 1:30 scale. The custom miniature figurine 138 includes at least a 3D scanned head of the user 144 and a pre-sculpted body.

It should be appreciated that the 3D representation of the head 154 of the user 144 includes a photorealistic face of the user 144. The head 154 of the custom miniature figurine 138 is typically scaled to be 15-25% larger than an anatomical head. It should be appreciated that the scaling of delicate features, such as hands, are most often scaled 15-25% larger than normal to be clearly visible to an individual at an arm's length on a tabletop.

As described herein, a method of printing may include layering UV inks. This process may also include use of a conductive metal ink, which is used to create wearable electronics and circuitry, and is often used to create simple prototype circuit boards. The conductive ink may be printed onto the packaging 200 (or the “Adventure Box”) with either the same method as the UV Ink, that being a Piezoelectric inkjet printhead, or via simpler methods such as Screen Printing. In some examples, the conductive ink may be laid down independently on a specific area on the packaging 200 (or the “Adventure Box”) or on a thin film to simplify the process.

Printing in the conductive ink bridges the gap between the digital and physical playing environments, creating a hybrid digital-physical board gaming experience. Circuitry may also be used to connect simple electronics, such as Near Field Communication (NFC) devices, temperature sensors, LED lights, etc. This could enhance player interactions with the packaging 200 (or the “Adventure Box”) in a similar way as already described with the use of QR codes, but could be expanded to cover more complex interactions, such as the recording of the location of physical playing pieces on a game board. For instance, this could enable communications between the physical playing surface (e.g., the packaging 200 (or the “Adventure Box”)) and the application 140, sending information such as the location of a playing piece, or updating the game's “score” when a physical trigger is activated on the board. The application 140 could also be used to activate simple electronic actions, such as causing an LED to activate. NFC sensors and triggers could be used as a way of augmenting a wide range of actions, such as drawing a virtual playing card from an NFC “deck” onto the computing device 222, rather than physically drawing and receiving a real-world card.

When combined with the use of AR/VR headsets, such as the Microsoft Hololens (where reality is augmented, but still visible to a wearer), additional possibilities appear. Tracking the location of a playing piece could allow for a player to measure distances using a digital ruler, or to restrict or augment their vision virtually. For example, an effect such as a vision-obstructing “Fog of War” similar to a video game could be implemented in a physical board gaming environment, blocking the vision of each individual player differently based upon the physical location of their playing piece upon the board game table.

Further, a full integration of remote digital players into a physical board gaming experience is contemplated herein. With the ability to track and send information from the physical board (e.g., the packaging 200 (or the “Adventure Box”)) to the application 140, a remote player could be added into a game digitally via AR/VR, where their digital playing pieces could appear for the physical players alongside their real-world playing pieces. This would mean that a player in Europe could enjoy taking part in a physical board game with their friends in the United States, not only appearing on the table as a digital-physical figurine designed through the scanning and tracking process described herein, but even as a digital avatar in the room itself based on the QR anchors described herein. This player could be playing entirely on the application 140, or even on their own integrated packaging 200 (or the “Adventure Box”).

As shown in FIG. 6 and in some examples, the custom miniature figurine 138 also includes accessories 160 (e.g., a sword or a pet), assets (e.g., digital hair or hats), and/or the base 162 that has a size between approximately 25 mm to approximately 75 mm. The base 162 provides a location for the custom miniature figurine 138 to stand on. In some examples, the base 162 is a circular platform. However, a shape of the base 162 is not limited to any particular shape. In other examples, the custom miniature figurine 138 may also include a personalized nameplate 164 with embossed text and/or a debossed order number 130. In further examples, a neck portion 156 may be added to the custom miniature figurine 138 to smooth a connection between the head portion 154 and the body model 158.

It should be appreciated that though the automated distributed manufacturing system is described to print tactile textures (e.g., playing surfaces) and integrated physical anchors on the packaging 200 (or the Adventure Box), in some implementations, the automated distributed manufacturing system may also be used to print the custom miniature figurines 138. In other implementations, the automated distributed manufacturing system may be used solely to print the custom miniature figurines 138.

Though similar processes to the ARMM system exist, the ARMM system described herein provides numerous benefits. The ARMM system of the instant invention is unique in that: (1) it is accessed from a mobile application 140 via the computing device 222 (e.g., a smartphone, tablet, or other mobile device), (2) it allows the user 144 to select a pose for the desired model, (3) it provides the user 144 with pre-made poses (e.g., for just the right arm, from shoulder to fingertip or for just the legs), (4) the partial-posing technique can also be modified through the use of partial-tracking, and (5) it provides customization and allows for separable and swappable parts.

These method differences also culminate in the final difference between the ARMM system and competing systems: the purpose. Similar existing processes aim to provide the user 144 with custom miniatures, while the models described herein, and by extension models produced using the ARMM system, aim to provide personalized miniatures (e.g., the custom miniature figurines 138). The key difference being that custom miniatures do not contain any aspect of the actual user. Any user 144 could pick the same options and receive the exact same model. Personalized miniatures (e.g., the custom miniature figurines 138) of the present invention are unique to the user, and contain some part of them. As described, the personalized and customized miniature figurine 138 includes the user's head 154, and is therefore unique to them and represents them, at least to a considerably greater degree than a typical custom miniature would. The ARMM-produced model, then, goes even further to include the user's pose as well, modifying the desired model to the user 144 even more and thereby strengthening the unique relationship between the user 144 and the custom miniature figurine 138. To this end, the ARMM system is entirely unique and irreplaceable.

Moreover, it should be appreciated that there are other methods contemplated herein of adding parts together during the ARMM process. These methods may be used to combine at least one 3D scan-derived model and at least one pre-sculpted object (typically scan-derived head and pre-sculpted body) for use in manufacturing the custom miniature figurine 138 or for use in an AR/VR digital space. In the first method, in global XYZ cartesian coordinates, the user-selected pre-sculpted body, user-selected pre-sculpted base, and 3D scan-derived head are placed at predefined coordinates. Optionally, a user-selected pre-sculpted nameplate and user-selected accessories are also placed at predefined coordinates. An order number text object is created and placed at predefined coordinates. If a nameplate is present, the name text object is created and placed at predefined coordinates. The application 140 merges all of the objects together, except for the model number, which is debossed from one of the models present. Optionally, a neck object can be placed at the intersection of the head and body, in which case it is “shrink-wrapped” to the two other models, to smooth the connection point. Lastly, “cleaning” operations are performed by the application 140 (to fill any holes that may have formed, split concave faces, and remove duplicate faces). To note, the body model is pre-sculpted with supports already in place so that the assembled model is now ready for production. The assembled model is then sent to the back-end interface for manufacture.

In another method, instead of predefined global coordinates, parts could be placed at predefined coordinates local to the parent object (e.g. the location to place the head is a set of coordinates local to the body). By placing these objects relative to a parent object, objects can be added easily when there are differences in the pose of the pre-sculpted model. Specifically, this means that the application 140 manipulates a body model using the AR/VR body tracking, certain types of objects or props may still be placed on the model. For example, instead of saying that your hat is located at X,Y,Z coordinates, the application 140 could say that your hat is located X,Y,Z above your “Head” parent object-allowing the application 140 to place the hat securely onto your head regardless of how much you moved around.

Predefined “joint” objects (with predefined coordinates) could be created and appended to the individual parts, such that, for example, the head object has a ‘neck’ joint, which is automatically aligned with the corresponding ‘neck’ joint on the body object. This would give additional advantages for certain types of props and objects, such as an item held in a hand or props that were articulated in some fashion. For example, if a sword were added to a “joint” in the palm of your hand, the object would travel and orient itself correctly as your tracked skeleton, specifically your arm, moved around. For certain parts, capturing the rotation and allowing manipulation as if it were an extension of the body could offer advantages when attempting to pose and model a figurine.

The present invention also contemplates combining a head object and a body object to create a completed 3D model for 3D printing the custom miniature figurine 138 or for use in AR/VR. Optionally, the present invention also contemplates combining accessories/additional parts, such as alternate hands, which can be swapped by the user 144. Put another way, the product does not merely need to be the eventual 3D printed figurine, as the creation of a digital avatar in AR/VR is a novel and interesting product in and of itself. When combined with the AR/R triggers and capabilities of the packaging 200 (or the Adventure Box) and the application 140, there are multiple exciting new possibilities to bridge the gap between digital and physical tabletop gaming.

Computing Device

FIG. 22 is a block diagram of a computing device included within the computer system, in accordance with embodiments of the present invention. In some embodiments, the present invention may be a computer system, a method, and/or the computing device 222 (of FIG. 22). A basic configuration 232 of the computing device 222 is illustrated in FIG. 22 by those components within the inner dashed line. In the basic configuration 232 of the computing device 222, the computing device 222 includes a processor 234 and a system memory 224. In some examples, the computing device 222 may include one or more processors and the system memory 224. A memory bus 244 is used for communicating between the one or more processors 234 and the system memory 224.

Depending on the desired configuration, the processor 234 may be of any type, including, but not limited to, a microprocessor (μP), a microcontroller (μC), and a digital signal processor (DSP), or any combination thereof. Further, the processor 234 may include one or more levels of caching, such as a level cache memory 236, a processor core 238, and registers 240, among other examples. The processor core 238 may include an arithmetic logic unit (ALU), a floating point unit (FPU), and/or a digital signal processing core (DSP Core), or any combination thereof. A memory controller 242 may be used with the processor 234, or, in some implementations, the memory controller 242 may be an internal part of the memory controller 242.

Depending on the desired configuration, the system memory 224 may be of any type, including, but not limited to, volatile memory (such as RAM), and/or non-volatile memory (such as ROM, flash memory, etc.), or any combination thereof. The system memory 224 includes an operating system 226, one or more engines, such as the application 140, and program data 230. In some embodiments, the application 140 may be an engine, a software program, a service, or a software platform, as described infra. The system memory 224 may also include a storage engine 228 that may store any information disclosed herein.

Moreover, the computing device 222 may have additional features or functionality, and additional interfaces to facilitate communications between the basic configuration 232 and any desired devices and interfaces. For example, a bus/interface controller 248 is used to facilitate communications between the basic configuration 232 and data storage devices 246 via a storage interface bus 250. The data storage devices 246 may be one or more removable storage devices 252, one or more non-removable storage devices 254, or a combination thereof. Examples of the one or more removable storage devices 252 and the one or more non-removable storage devices 254 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 256 facilitates communication from various interface devices (e.g., one or more output devices 280, one or more peripheral interfaces 272, and one or more communication devices 264) to the basic configuration 232 via the bus/interface controller 256. Some of the one or more output devices 280 include a graphics processing unit 278 and an audio processing unit 276, which are configured to communicate to various external devices, such as a display or speakers, via one or more A/V ports 274.

The one or more peripheral interfaces 272 may include a serial interface controller 270 or a parallel interface controller 266, which are configured to communicate with external devices, such as input devices (e.g., a keyboard, a mouse, a pen, a voice input device, or a touch input device, etc.) or other peripheral devices (e.g., a printer or a scanner, etc.) via one or more VO ports 268.

Further, the one or more communication devices 264 may include a network controller 258, which is arranged to facilitate communication with one or more other computing devices 262 over a network communication link via one or more communication ports 260. The one or more other computing devices 262 include servers (e.g., the server 102), the database (e.g., the database/local storage/network storage 106), mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 224, the one or more removable storage devices 252, and the one or more non-removable storage devices 254 are examples of the computer-readable storage media. The computer-readable storage media is a tangible device that can retain and store instructions (e.g., program code) for use by an instruction execution device (e.g., the computing device 222). Any such, computer storage media is part of the computing device 222.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 234 of a general purpose computer, special purpose computer, or other programmable data processing apparatus (e.g., the computing device 222) to produce a machine, such that the instructions, which execute via the processor 234 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 222), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system configured to create a custom miniature figurine, the system comprising:
a database;
a server;
a computing device comprising:
a graphical user interface (GUI);
a camera;
an application configured to:
utilize the camera to scan a head of a user and create a three-dimensional (3D) representation of the head of the user;
combine the 3D representation of the head of the user with a pre-sculpted digital body and accessories selected by the user via the GUI to create a work order; and
transmit the work order to an automated distributed manufacturing system;
the automated distributed manufacturing system being configured to:
receive the work order from the application;
perform digital modeling tasks and assemble a digital model; and
transmit the digital model to a 3D printing apparatus; and
the 3D printing apparatus being configured to:
receive the digital model; and
create the custom miniature figurine.

2. The system of claim 1, wherein the application comprises an augmented reality (AR) process configured to:
track movement values and pose values of the user; and
apply at least a portion of the movement values and the pose values to the digital model.

3. The system of claim 2, wherein the AR process comprises an augmented reality miniature maker (ARMM).

4. The system of claim 1, wherein the automated distributed manufacturing system is configured to:
print tactile textures and integrated physical anchors on a packaging.

5. The system of claim 4, wherein the printing of the tactile textures and the integrated physical anchors on the packaging occurs by layering ultraviolet (UV) curable ink.

6. The system of claim 4,
wherein the integrated physical anchors comprise integrated QR codes, and
wherein scanning the QR codes by the camera creates audiovisual effects and/or digital models that appear via augmented reality (AR).

7. The system of claim 4, wherein the packaging is configured to unfold and disassemble to reveal a board game.

8. The system of claim 4, wherein the tactile textures comprise playing surfaces.

9. The system of claim 1, wherein the application comprises an automated miniature assembly (AMA) script configured to automate an assembly of the digital model.

10. The system of claim 1, wherein the digital model is 3D printed as the custom miniature figurine for use in tabletop gaming or is used with packaging as a digital avatar presented in augmented reality (AR).

11. A method executed by an application of a computing device to create a custom miniature figurine, the method comprising:
using a camera of a computing device to take measurements of a head of a user;
compiling the measurements of the head of the user into a three-dimensional (3D) representation of the head of the user;
combining the 3D representation of the head of the user with a pre-sculpted digital body and accessories selected by the user via a graphical user interface (GUI) of the computing device to create a work order; and
transmitting the work order to an automated distributed manufacturing system that is configured to:
perform digital modeling tasks;
assemble a digital model; and
transmit the digital model to a 3D printing apparatus, wherein the 3D printing apparatus is configured to create the custom miniature figurine from the digital model.

12. The method of claim 11, wherein the application comprises an automated miniature assembly (AMA) script configured to automate an assembly of the digital model.

13. The method of claim 11, wherein the application comprises an augmented reality (AR) miniature maker (ARMM) configured to:
track movement values and pose values of the user; and
apply at least a portion of the movement values and the pose values to the digital model.

14. The method of claim 11, wherein the automated distributed manufacturing system is configured to:
print tactile textures on a packaging by layering ultraviolet (UV) curable ink;
printing conductive ink on the packaging; and
print integrated physical anchors on the packaging.

15. The method of claim 14,
wherein the integrated physical anchors comprise integrated QR codes, and
wherein scanning the QR codes via the camera creates audiovisual effects and/or digital models that appear via augmented reality (AR).

16. The method of claim 14, wherein the packaging is configured to unfold and disassemble to reveal a board game.

17. The method of claim 11, wherein the custom miniature figurine is a tabletop miniature figurine used for tabletop gaming.

18. The method of claim 17, wherein a size of the custom miniature figurine ranges from approximately 1:56 to approximately 1:30 scale.

19. The method of claim 17, wherein the custom miniature figurine comprises a base.

20. The method of claim 19, wherein a size of the base ranges from approximately 25 mm to approximately 75 mm.
